(19) United States
(12) Patent Application Publication
(10) Pub. No.: US 2020/0372440 A1
(43) Pub. Date: Nov. 26, 2020

(54) SYSTEM FOR STAGGERED PARTIAL ORDER INDUCTION INTO AUTOMATED STORAGE

(71) Applicant: Walmart Apollo, LLC, Bentonville, AR (US)

(72) Inventors: Colin Holmes, Bentonville, AR (US); David G. Tovey, Rogers, AR (US); Henk Niemansverdriet, Bentonville, AR (US); Boyd Bryant, Bella Vista, AR (US)

(21) Appl. No.: 16/876,964

(22) Filed: May 18, 2020

Related U.S. Application Data
(60) Provisional application No. 62/850,655, filed on May 21, 2019.

(51) Int. Cl. G06Q 10/08; G06F 16/9035; G06F 16/904; G06F 16/909

(52) U.S. Cl. CPC G06Q 10/08; G06F 16/909; G06F 16/904; G06F 16/9035

(57) ABSTRACT

Examples provide a system for staggering induction of items into an automated storage device. Multiple partial order totes containing items for fulfillment of multiple different orders can be inducted into an automated storage device simultaneously. The parts of a multipart order can also be inducted into the automated storage device at staggered intervals. The system tracks each part of each multipart order inducted into the system to monitor the location of each tote containing items for fulfilling each order, the induction duration each tote has been inside the automated storage system, and unreceived items which are part of the multipart order but which have not yet been inducted into the item storage device. The system outputs notifications associated with received items, unreceived items, tote locations, aggregation of partial order totes and/or threshold wait times associated with inducting all parts of an order into the automated storage device.

### BACKGROUND

Typically, when a customer purchases multiple items in a single order, all the items in the order are collected together in a staging area prior to storing or dispensing the items to the customer for pickup. If the order includes frozen or chilled items, the collection of chilled and frozen items may have to be staged in a refrigerated area or other temperature-controlled location until all portions of the order are collected. This can be a time-consuming and inefficient process for users gathering items for fulfillment of each order.

### SUMMARY

Some examples provide a system for managing staggered induction of partial orders into automated storage. The system includes at least one processor communicatively coupled to a memory. A scan device scans each item placed into a first partial order tote associated with a first portion of a multipart order created by a selected user. A first removable tote label identifying the first partial order tote and the multipart order is generated. An induction portal inducts the first partial order tote, including the first removable tote label, into an automated storage device at a first induction time-period on condition the first portion of the multipart order is complete. A second portion of the multipart order is incomplete when the first partial order tote is inducted. A user interface device outputs an order status identifying received items in the multipart order inducted into the automated storage device, an induction time of each partial order tote, and unreceived items from the multipart order un-inducted into the system based on the multipart order data associated with at least one removable tote label on at least one tote inducted into the automated storage device. An order manager component implemented on the at least one processor outputs an alert on condition a second partial order tote associated with a second portion of the multipart order remains unreceived after a threshold maximum wait time.

Other examples provide a computer-implemented method for staggered induction of partial order totes into a storage device. A first partial order tote associated with a first multipart order is inducted into an automated storage device at a first induction time while a remaining portion of the first multipart order is unpicked. The first partial order tote includes a first removable tote label identifying the first multipart order and the first partial order tote. A second partial order tote associated with the first multipart order is inducted into the automated storage device at a second induction time. The second partial order tote includes a second removable tote label identifying the first multipart order and the second partial order tote. The second induction time occurs after the first induction time. A user interface device outputs an incomplete order notification associated with the first multipart order including an identification of each item in a set of unreceived items and an induction duration for each item in a set of received items associated with the multipart order inducted into the automated storage device. An alert component generates a notification identifying a set of unreceived items associated with the first multipart order on condition a set of unreceived items associated with the first multipart order remains un-inducted into the automated storage device at an occurrence of a maximum wait threshold time following induction of the first partial order tote.

Still other examples provide a computer storage media, having computer-executable instructions for staggering induction of totes into a storage device. When executed by a computer, the computer-executable instructions cause the computer to identify a first set of items within a first partial order tote based on scan data generated by a set of sensor devices. A removable tote label identifying the first partial order tote and a first multipart order corresponding to the set of items is generated. The first partial order tote is inducted into an automated storage device at a first induction time via an induction portal. The first partial order tote is routed to a holding area within the automated storage device on condition at least a portion of the first multipart order remains un-inducted into the automated storage system. A partial order induction notification is output via a user interface device identifying the set of received items inducted into the automated storage system and a set of unreceived items associated with the multipart order. The user interface device displays a graphical representation of each partial order tote in a set of partial order totes associated with the first multipart order relative to a plurality of other partial order totes within the automated storage device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for staggering induction of partial orders into an automated item storage device.

FIG. 2 is an exemplary block diagram illustrating an order manager component.

FIG. 3 is an exemplary block diagram illustrating a set of partial order totes.

FIG. 4 is an exemplary block diagram illustrating a removable tote label.

FIG. 5 is an exemplary block diagram illustrating a closed induction drawer associated with a set of induction points into an automated storage device.

FIG. 6 is an exemplary block diagram illustrating an open induction drawer associated with a set of induction points into an automated storage device.

FIG. 7 is an exemplary block diagram illustrating a set of multipart orders.

FIG. 8 is an exemplary block diagram illustrating a map including a set of graphical representations of locations for each partial order tote stored inside an automated storage device.

FIG. 9 is an exemplary block diagram illustrating a database storing data associated with staggered induction of partial orders into an automated storage device.

FIG. 10 is an exemplary block diagram illustrating a set of sensor devices for generating sensor data associated with items and totes inducted into an automated storage device.

FIG. 11 is an exemplary flow chart illustrating operation of the computing device to induct partial orders into an automated storage device.

FIG. 12 is an exemplary flow chart illustrating operation of the computing device to monitor partial order totes inducted into an automated storage device at staggered intervals.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Referring to the figures, examples of the disclosure enable staggered induction of partial orders into an automated tote storage device. In some examples, an order manager tracks the induction time, induction duration, tote location and missing/unreceived items associated with each partial order inducted into the storage device. The system issues notifications associated with induction duration of each tote, contents of each tote, location of each tote and requests for unreceived items needed to fulfill an incomplete order. As used herein, the term “tote” refers to a container, box, storage tote or other receptacle for holding one or more items. A tote can have a lid in some examples. In other examples, the tote can have an open top with no lid. A tote can be insulated or uninsulated.

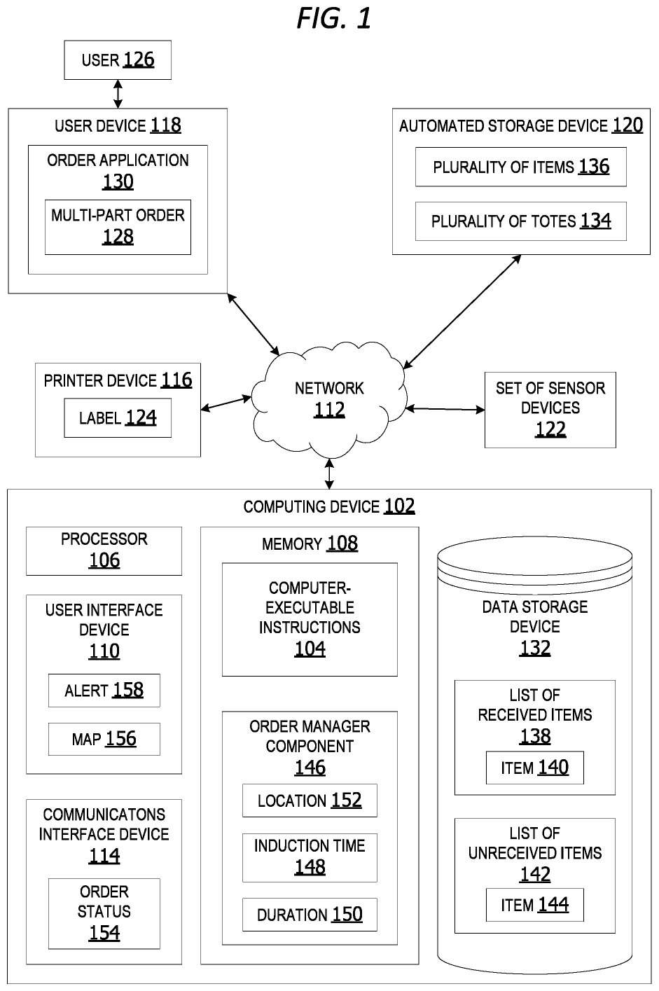

Referring again to FIG. 1, an exemplary block diagram illustrates a system 100 for system for staggering induction of partial orders into an automated item storage device. In the example of FIG. 1, the computing device 102 represents any device executing computer-executable instructions 104 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102 in other examples includes a user interface device 110.

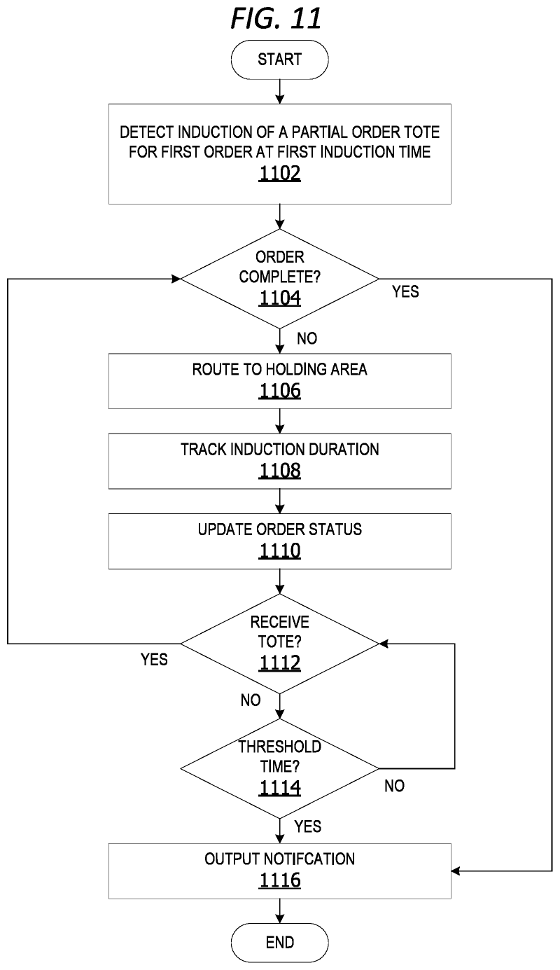

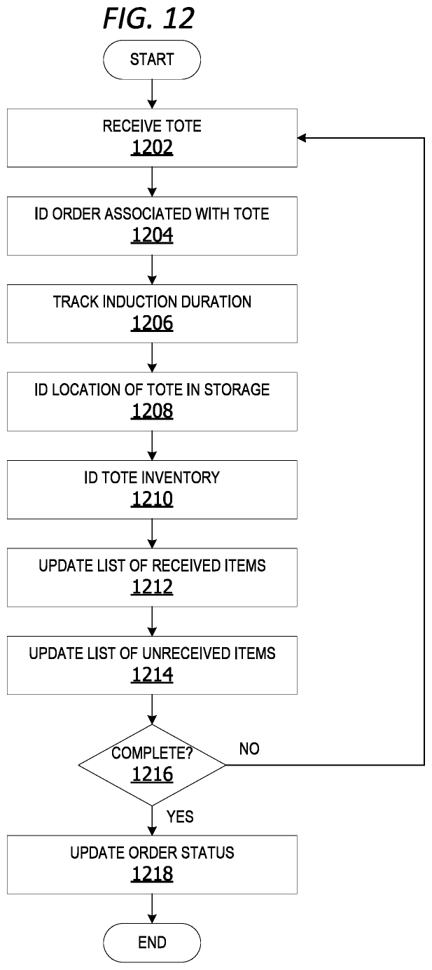

The processor 106 includes any quantity of processing units, and is programmed to execute the computer-executable instructions 104. The computer-executable instructions 104 is performed by the processor 106, performed by multiple processors within the computing device 102 or performed by a processor external to the computing device 102. In some examples, the processor 106 is programmed to execute instructions such as those illustrated in the figures (e.g., FIG. 11 and FIG. 12).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to a printer device 116, a user device 118, an automated storage device 120 and/or a set of sensor devices 122, can occur using any protocol or mechanism over any wired or wireless connection. In some examples, the communications interface component 114 is operable with short range communication technologies such as by using near-field communication (NFC) tags.

The printer device 116 is a network enabled printer configured to print removable tote labels. A removable tote label 124 is a label which can be removably attached to a tote containing one or more items for fulfillment of a multipart order 128. A tote label in this example includes an order identifier and a tote identifier. The tote label 124 can optionally also include a name of a user 126 that created the multipart order 128, a date, a time, a barcode, a quick response (QR) code or any other type of order data for the multipart order 128.

The user device 118 represent any device executing computer-executable instructions. The user device 118 can be implemented as a mobile computing device, such as, but not limited to, a wearable computing device, a mobile telephone, laptop, tablet, computing pad, netbook, gaming device, and/or any other portable device. The user device 118 includes at least one processor and a memory. The user device 118 can also include a user interface component.

In this non-limiting example, the user device 118 implements an order application 130 enabling the user 126 to create the multipart order 128. The order application 130 can be downloaded from a server, such as, but not limited to, a cloud server.

A cloud server is a logical server providing services to the computing device 102 or other clients, such as, but not limited to, the user device 118. The cloud server can be hosted and/or delivered via the network 112. In some non-limiting examples, the cloud server is associated with one or more physical servers in one or more data centers. In still other examples, the cloud server is associated with a distributed network of servers.

The automated storage device 120 is an automated tote storage system for storing a plurality of totes 134 containing a plurality of items 136. The plurality of items 136 can include ambient temperature items, chilled items and/or frozen items. Chilled items are items which are stored in at refrigerator temperatures, such as milk or butter. Frozen items are items which are maintained in a frozen state, such as ice cream. The plurality of totes 134 can include a set of partial order totes storing one or more items inside each tote. The plurality of totes 134 can also include a set of empty totes.

The set of sensor devices 122 is a set of one or more sensor devices for generating sensor data associated with each item placed into a tote prior to induction of the tote into the automated storage device 120. The set of sensor devices 122 can include, without limitation, a barcode reader, a QR code reader, a radio frequency identification (RFID) tag reader, a camera, an optical reader, or any other type of sensor device.

The system 100 can optionally include a data storage device 132 for storing data, such as, but not limited to a list of received items 138 inducted into the automated storage device 120, such as an item 140. The data storage device 132 can also store data, such as, but not limited to, a list of unreceived items 142 not yet inducted into the automated storage device 120, such as, but not limited to, item 144. In other words, the item 144 is an item requested by the user 126 in the multipart order 128 which has not yet been picked and/or placed into the automated storage device 120.

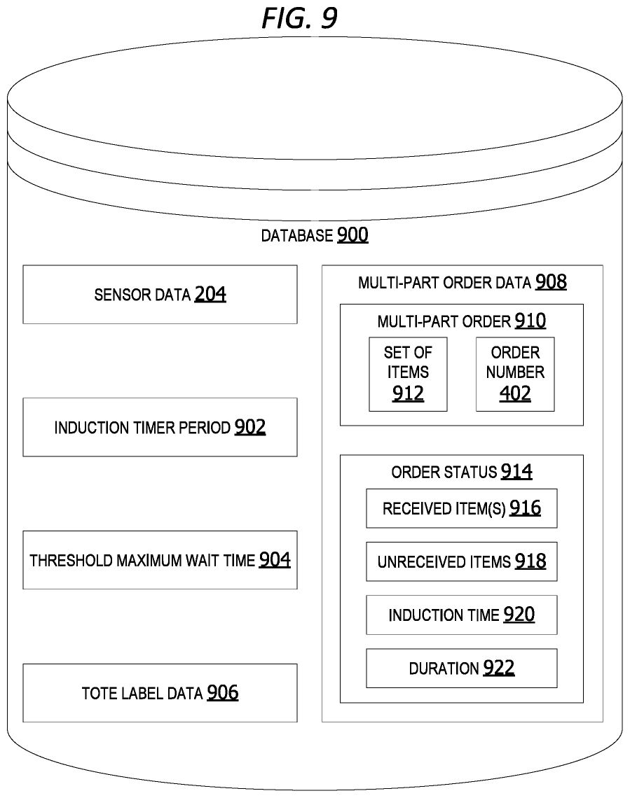

The data storage device 132 can include one or more different types of data storage devices, such as, for example, one or more rotating disks drives, one or more solid state drives (SSDs), and/or any other type of data storage device. The data storage device 132 in some non-limiting examples includes a redundant array of independent disks (RAID) array. In other examples, the data storage device 132 includes a database, such as, but not limited to, the database 900 in FIG. 9.

The data storage device 132 in this example is included within the computing device 102 or associated with the computing device 102. In other examples, the data storage device 132 includes a remote data storage accessed by the computing device via the network 112, such as a remote data storage device, a data storage in a remote data center, or a cloud storage.

The memory 108 in some examples stores one or more computer-executable components. Exemplary components include an order manager component 146. The order manager component 146 is executed by the processor 106 of the computing device 102. The order manager component 146 analyzes sensor data generated by the set of sensor devices 122 to identify each item placed into a partial order tote associated with a first portion of a multipart order created by the user 126. The order manager component 146 generates a first removable tote label 124 identifying the first partial order tote and the multipart order 128. The tote label is printed on a printer device 116 for placement on the partial order tote prior to induction of the tote into the automated storage device 120.

In other examples, the order manager component 146 logs/records an induction time 148 for the partial order tote when the partial order tote in inducted into the automates storage device 120. The induction time 148 include a date and/or time when the tote is received into the automated storage device 120. The order manager component 146 monitors induction duration 150. The induction duration 150 is the duration of time from the induction time 148 to the current time. For example, if the partial order tote was inducted into the automated storage device 120 at 1:00 p.m., the induction duration 150 at 2:00 p.m. is one hour.

The order manager component 146 in other examples, monitors the location 152 of each partial order tote containing item(s) for fulfillment of a given multipart order, such as, but not limited to, the multipart order 128. The location 152 is the storage location within the automated storage device. The location 152 can be indicated as an address of a storage slot, a storage identifier, a graphical representation on a map 156, or any other location data. The map 156 can be output via the user interface device 110 or transmitted to a user device associated with a user inducting items into the automated storage device 120.

In still other examples, the order manager component 146 generates an order status 154 for each multipart order which is pending. A pending order is an order which has been created by the user but has not yet been picked up/received by the user. The order status 154 in this example includes a list of order items which have been received into the automated storage device 120 and/or a list of order items which have not yet been received (unreceived items) into the automated storage device 120. The order manager component can output an alert 158 via the user interface device 110 if a second partial order tote associated with a second portion of the multipart order remains unreceived after a threshold maximum wait time. In other words, if part of an order is not received/inducted into the automated storage device within a threshold time-period after induction of another portion of the same order, the alert 158 is output to notify user(s) of the incomplete status of the order.

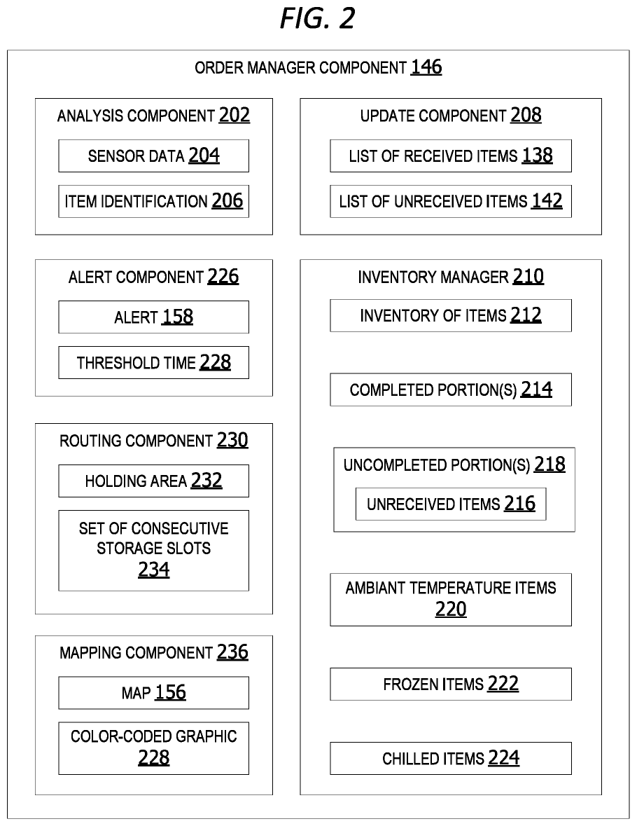

FIG. 2 is an exemplary block diagram illustrating an order manager component 146. The order manager component 146 in some examples includes an analysis component 202 that analyzes sensor data 204 generated by one or more sensor devices scanning each item placed into a partial order tote prior to induction of the tote. The sensor data 204 can also include sensor data generated by one or more sensor devices scanning a tote identifier on each tote inducted into the automated storage device. In still other examples, the sensor data 204 is generated when a sensor device scans a removable tote label on a partial order tote, such as, but not limited to, the label 124 in FIG. 1. The order manager component 146 analyzes the sensor data in some examples to generate an inventory of items in each tote.

After a partial order tote is inducted into the automated storage device, an update component 208 updates a list of unreceived items 142 which have not yet been inducted into the automated storage device. The update component 208 can also update a list of received items 138 which have been inducted into the automated storage device when a partial order tote containing a portion of the multipart order is successfully inducted into the automated storage device. The update component 208 can be updated based on an inventory of items in each tote that is inducted into the system.

The inventory of items 212 in each tote can be generated, in some examples, by an inventory manager 210. The inventory of items 212 can include an inventory of received items in completed portion(s) 214 of an order and/or unreceived items 216 associated with uncompleted portion(s) 218 of the order. The items in a given tote tracked by the inventory manager 210 can include ambient temperature items 220, frozen items 222 and/or chilled items 224. In some examples, frozen items 222 are inducted into the automated storage device inside an insulated tote. The insulation maintains the frozen temperature of the items for extended periods of time inside the automated storage device.

An alert component 226 in some examples generates an alert 158 identifying a set of unreceived items associated with the first multipart order on condition a set of unreceived items associated with the first multipart order remains un-inducted/unreceived into the automated storage device at an occurrence of a maximum wait threshold time 228.

A routing component 230 routes the first partial order tote to a holding area 232 within the automated storage device until all partial order totes associated with the multipart order are inducted into the system. The routing component 230, in other examples, routes a set of partial order totes associated with the multipart order to a set of consecutive storage slots 234 within the automated storage device.

The order manager component 146 in still other examples includes a mapping component 236. The mapping component 236 outputs an identification of a location of each tote in the set of partial order totes to at least one user via the user interface device. The location can be provided via graphical representations of each tote on a map 156 displayed on the user interface device. In this example, the graphical representation includes a square or rectangle representing each partial order tote displayed on a grid or other map representing each available tote storage space in the automated storage device.

In some non-limiting examples, the mapping component 236 outputs a graphical representation of a location of each partial order tote in a first set of partial order totes associated with a given multipart order using a unique color-coded graphic. In other words, the graphical representation of each tote that is part of the same tote can be depicted using a color associated with the order. In other examples, the graphical representation of each tote that is part of the same multipart order includes an order number associated with the multipart order.

The color-coded graphic can represent different orders, such that all totes containing portions of a given order are representing in the same color while totes containing portions of a different order are represented using a different color. The color-coded graphic can also represent a stage of the order aggregation. For example, incomplete orders can be represented in a first color while completed orders are represented in a different color.

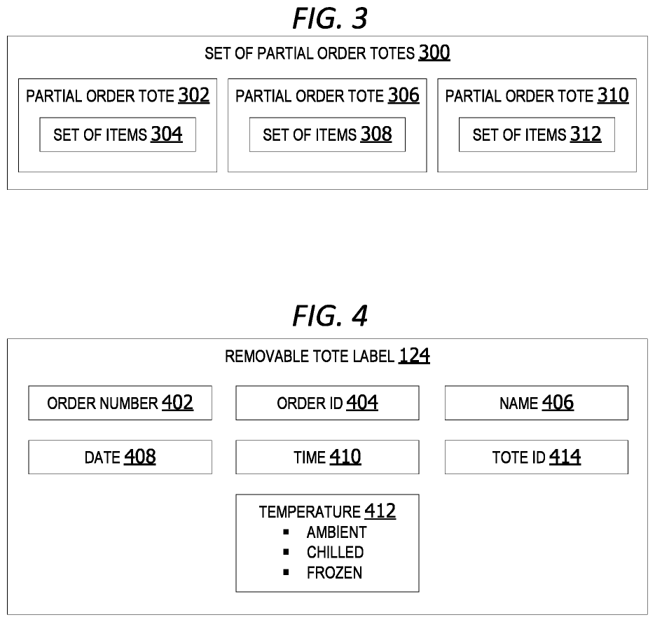

FIG. 3 is an exemplary block diagram illustrating a set of partial order totes 300. The set of partial order totes 300 includes two or more totes holding items for fulfillment of one or more orders created by user. The set of partial order totes 300 in this example includes a first partial order tote 302 holding a set of one or more items 304 requested by a first user in a first multipart order. The second partial order tote 306 holds a set of one or more items 308 requested by a second user in a second multipart order. The third partial order tote 310 includes a set of one or more items 312 requested by a third user in a third multipart order.

In other examples, the first partial order tote 302, the second partial order tote 306 and the third partial order tote can include items requested by the same user in the same multipart order. In still other examples, the first partial order tote 302 and the second partial order tote 306 contain items requested by a first user in a first multipart order while the third partial order tote 310 includes the set of items 312 requested by a different second user in a second multipart order.

In this example, the set of partial order totes 300 includes three totes. In other examples, the set of partial order totes 300 can include a single tote, two totes, as well as four or more partial order totes.

FIG. 4 is an exemplary block diagram illustrating a removable tote label 124. The removable tote label 124 includes data associated with a partial order tote and the contents of the partial order tote. In this example, the removable tote label 124 includes an order number 402 identifying the multipart order created by the user. The order identifier (ID) 404 is a barcode, QR code or other scannable ID for identifying the partial order tote, the contents of the partial order tote and/or the multipart order created by the user.

The removable tote label 124 can optionally also include a name 406 of the user that created the multipart order (requested the items), a date 408, a time 410, and/or a temperature 412 of the items in the partial order tote. The temperature 412 can include ambient, chilled and/or frozen.

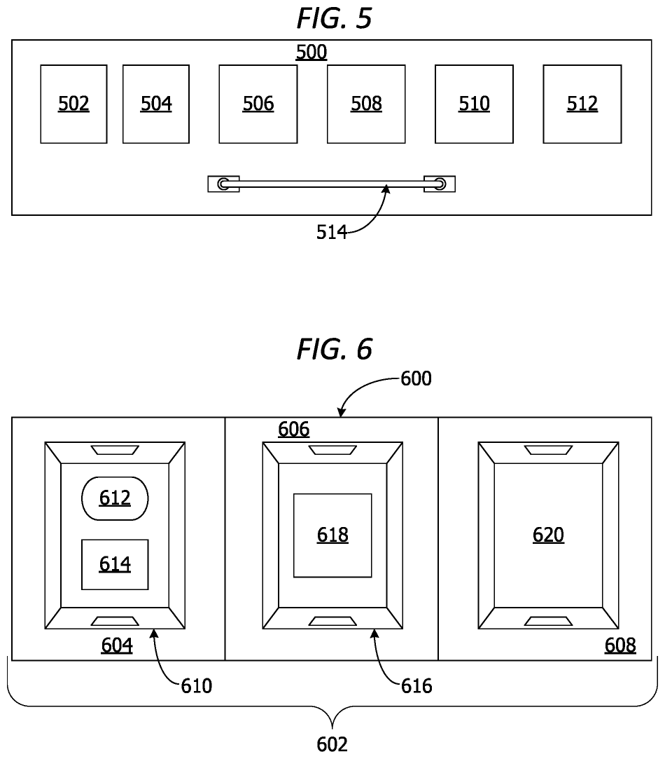

FIG. 5 is an exemplary block diagram illustrating a closed induction drawer 500 associated with a set of induction points into an automated storage device. The set of induction points is a set of one or more entry points for placing a tote into the automated storage device. In this example, the set of induction points includes an induction point 502, an induction point 504, an induction point 506, an induction point 508, an induction point 510 and an induction point 512. When the induction drawer is pulled open, a tote can be placed into a slot associated with each induction point. When the drawer is closed, each tote placed into an induction point is entered/inducted into the automated storage device.

In this non-limiting example, the set of induction points includes six induction points. In other examples, the set of induction points can include a single induction points, two induction points, three induction points, four induction points, five induction points, as well as seven or more induction points.

In this example, a single induction drawer is shown. In other examples, the automated storage device can include two or more induction drawers having a set of induction points.

FIG. 6 is an exemplary block diagram illustrating an open induction drawer 600 associated with a set of induction points 602 into an automated storage device. The set of induction points 602 in this example includes three induction points, induction point 604, induction point 606 and induction point 608. In other examples, the set of induction points includes a single induction point, a set of two induction points or a set of four or more induction points.

Each induction point in this example includes a partial order tote. In this example, the first partial order tote 610 includes an item 612 and an item 614. However, the set of items inside a tote are not limited to two items. The set of items can include a single item, as well as three or more items. The item 612 can be an individual item as well as a bag containing one or more items inside the bag. Likewise, the item 614 can be a single item or a bag or box containing one or more individual items inside the bag or box.

The tote 616 in the induction point 606 contains a single item 618. The item 618 can be an individual item or a bag or box containing one or more individual items. The tote 620 in the induction point 608 is an empty tote.

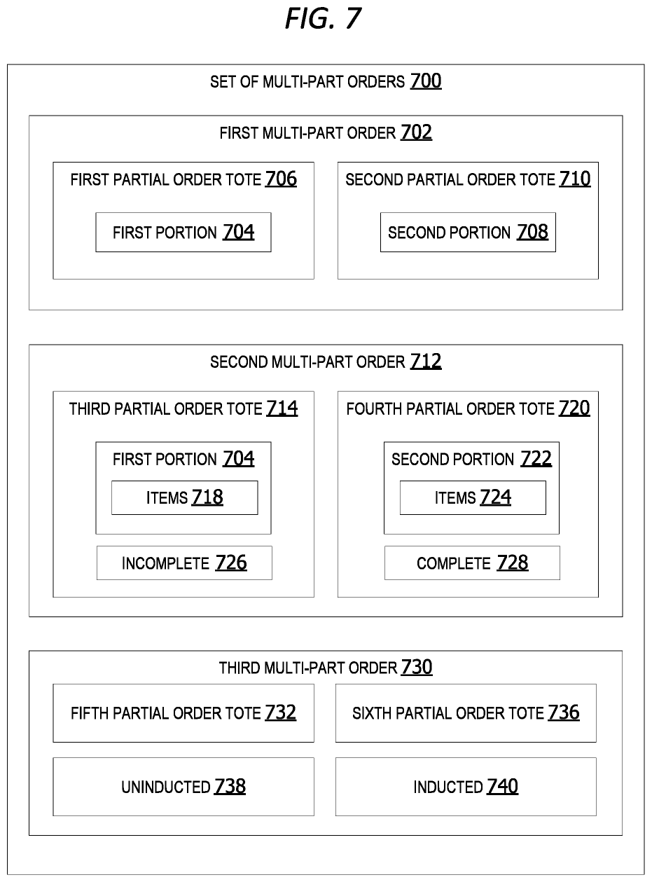

FIG. 7 is an exemplary block diagram illustrating a set of multipart orders 700. The set of multipart orders 700 includes one or more orders having two or more partial order totes containing items requested in the order. In other words, a multipart order is an order requesting at least two items which cannot be contained in a single tote. Therefore, two or more partial order totes are utilized to contain all the items ordered/requested by the user in the multipart order.

The first multipart order 702 in this example includes a first portion 704 of the order in a first partial order tote 706. The first portion 704 of the order includes one or more items requested by the user in the first multipart order 702. The second portion 708 of the order includes one or more other items requested in the first multipart order 702. The second portion of the order is contained within a second partial order tote 710. In this example, the first multipart order 702 includes two partial order totes. In other examples, the first multipart order 702 can include three or more partial order totes.

The second multipart order 712 is another order created by another user. The second multipart order 712 includes a first portion 716 of items 718 in a third partial order tote 714. The second portion 722 of items 724 are included within a fourth partial order tote 720. A multipart order is incomplete 726 when all the items for fulfillment of the order have not yet been inducted/received into the automated storage device. The multipart order 712 is complete 728 when all portion of the order have been received into the automated storage device.

The third multipart order 730 can likewise include items in a fifth partial order tote 732 and/or items in a sixth partial order tote 736. A partial order tote can be un-inducted 738 (unreceived) into the automated storage device. The partial order tote can also be inducted 740 into the automated storage device if the tote and its contents have already been received into the storage.

In some examples, partial order totes from many different orders can be inducted simultaneously into the automated storage device via the set of induction points. For example, the first partial order tote 706, the third partial order tote 714 and the sixth partial order tote 736 can be inducted at the same time into the automated storage system.

Likewise, multiple partial order totes for the same order can be inducted at the same time. In some examples, six totes can be inducted simultaneously at a single induction drawer. For example, but without limitation, the first partial order tote 706 and the second partial order tote 710 can be inducted together with the third partial order tote 714, the fourth partial order tote 720, the fifth partial order tote 732 and the sixth partial order tote 736.

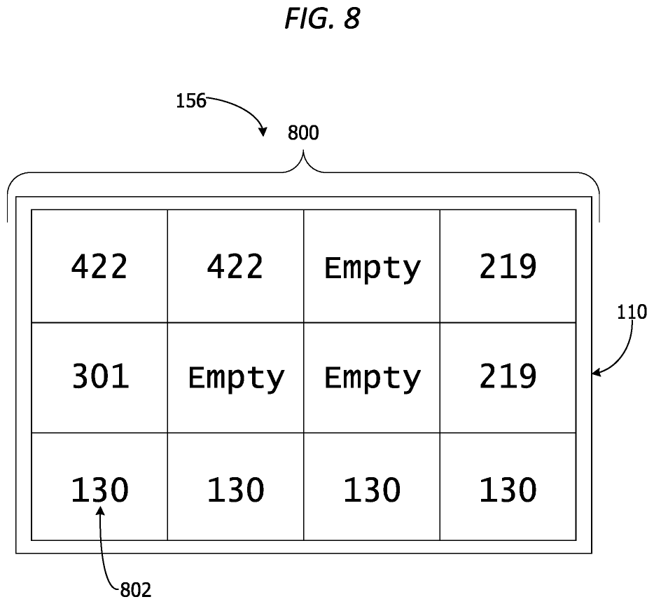

FIG. 8 is an exemplary block diagram illustrating a map 156 including a set of graphical representations 800 of locations for each partial order tote stored inside an automated storage device. For example, the graphical representation 802 represents a tote associated with an order number “130” in a set of consecutive storage locations containing five partial order totes storing items for the order “130.”

In this example, the map 156 displayed on the user interface device 110 shows two graphical representations for two totes holding a portion of order items for an order “422.” The set of graphical representations 800 also represents two graphical representations for two totes containing portions of an order “219.” There are also three graphical representations for three empty tote storage slots which are available for placement/storage of additional totes inducted into the system.

FIG. 9 is an exemplary block diagram illustrating a database 900 storing data associated with staggered induction of partial orders into an automated storage device. The database 900 in this non-limiting example stores data such as, but not limited to, the sensor data 204 generated by the set of sensor devices, an induction time-period 902 since a first tote in a set of partial order totes was inducted into the automated storage device, a user-configured threshold maximum wait time 904 to aggregate/induct all partial order totes for a given order into the automated storage device and/or tote label data 906 used to generate a removable tote label.

The database 900 can also store multipart order data, such as, but not limited to, multipart order 910 information and/or an order status 914 for each order. The multipart order 910 information can include an identification of a set of items 912 in the order and an order number 402 used to identify the order.

The order status 914 in some examples include order data, such as, but not limited to, an identification of received item(s) 916 requested in the order and inducted into the automated storage device, unreceived items 918 requested in the order but not yet received into the automated storage device, induction time 920 of each tote and/or induction time of each item received into the automated storage device. The order status 914 can also include the duration 922 each tote and/or item has spent inside the automated storage device since each tote and/or item was inducted into the automated storage system.

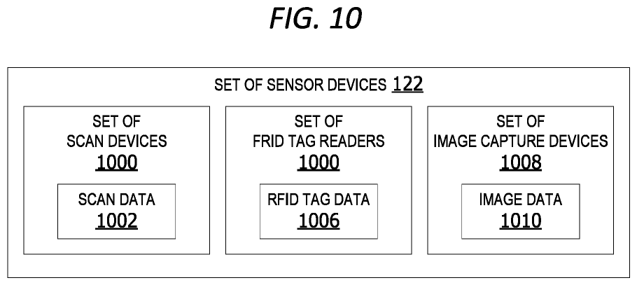

FIG. 10 is an exemplary block diagram illustrating a set of sensor devices 122 for generating sensor data associated with items and totes inducted into an automated storage device. In this non-limiting example, the set of sensor devices 122 includes a set of one or more scan devices 1000 generating scan data 1002. The set of scan devices 1000 can include a barcode scanner, such as, but not limited to, a matrix barcode scanner, a QR code scanner, a universal product code (UPC) reader, etc. The set of scan devices 1000 can also include a set of one or more RFID tag readers 1004 generating RFID tag data 1006 associated with one or more RFID tags on one or more items, such as a tote or an item inside the tote.

The set of sensor devices 122 can also includes a set of image capture devices 1008 generating image data 1010 associated with a tote and/or one or more items inside a tote. The set of image capture devices 1008 can include a camera, an infrared sensor or any other imaging device.

FIG. 11 is an exemplary flow chart illustrating operation of the computing device to induct partial orders into an automated storage device. The process shown in FIG. 11 is performed by an order manager component, executing on a computing device, such as the computing device 102 or the user device 118 in FIG. 1.

The process begins by detecting induction of a partial order tote for a first order at a first induction time at 1102. The order manager component determines whether the order is complete at 1104. The order is complete if all the items associated with the order have been inducted into the automated storage device. If the order is not complete, the order manager component routes the partial order tote to a holding area at 1106. The holding area is an area inside the automated storage device wherein partial order totes for a given order can be aggregated together. The order manager component tracks induction duration for the partial order tote at 1108. The induction duration is the amount of time which has passed since the partial order tote was inducted into the automated storage system. The order manager component updates an order status for the order at 1110. The order status includes an update of received items to include the inventory of items inside the inducted partial order tote.

The order manager component determines if another tote is received at 1112. If no, the order manager component determines if a threshold wait time has passed at 1114. If yes, the order manager component outputs a notification at 1116. The notification can be output via a user interface, such as the user interface device 110 in FIG. 1. The process terminates thereafter.

If an order is complete at 1104, the order manager component outputs a notification at 1116. The notification indicates all portions of the order have been aggregated/assembled inside the automated storage device and is ready for pickup. The process terminates thereafter.

While the operations illustrated in FIG. 11 are performed by a computing device, aspects of the disclosure contemplate performance of the operations by other entities. In a non-limiting example, a cloud service performs one or more of the operations.

FIG. 12 is an exemplary flow chart illustrating operation of the computing device to monitor partial order totes inducted into an automated storage device at staggered intervals. The process shown in FIG. 12 is performed by an order manager component, executing on a computing device, such as the computing device 102 or the user device 118 in FIG. 1.

The process begins by receiving a tote at 1202. The tote is received at an induction point, such as, but not limited to, a point in the set of induction points 602 in FIG. 6. The order manager component identifies the order associated with the inducted tote at 1204. The order manager component tracks induction of duration of the tote at 1206. The order manager component identifies the location of the tote in the automated storage device at 1208. The order manager component identifies the tote inventory at 1210. The tote inventory is an inventory of items inside the inducted tote. The order manager component updates the list of received items at 1212. The order manager component determines if the order is complete at 1216. If no, the process returns to 1202 and iteratively perform operations 1202 through 1216 until the order is complete. The order manager component updates the order status at 1218 to indicate the complete order status. The process terminates thereafter.

While the operations illustrated in FIG. 12 are performed by a computing device, aspects of the disclosure contemplate performance of the operations by other entities. In a non-limiting example, a cloud service performs one or more of the operations.

### ADDITIONAL EXAMPLES

In some examples, the system provides automatic retrieval of store items/orders. The system scans the orders to print removable tags for the orders. The system performs induction of the orders on receiving the orders. The system identifies order parts via the tags.

In other examples, the automated storage device is abutted to a store's stockroom such that the set of induction points are adjacent to the stockroom. This makes picking items into totes and induction of totes into the automated storage device faster and more efficient. Likewise, induction of partial orders at staggered intervals enables users to induct partial orders as they are assembled in real-time while eliminating staging areas. The partial orders are aggregated within the automated storage device without staging partial order totes prior to induction into the automated storage device.

Multiple associates can pick portions of an order and induct those portions of the order immediately without staging. All parts of an order do not need to be inducted together (complete). This enables fluid induction while minimizing floor space utilized during picking of items into totes where a staging area is not necessary.

Partial orders can be picked and/or inducted by human users or by autonomous robots. In one example, a robotic picker device retrieves the first set of items corresponding to the first portion of the multipart order, wherein the robotic picker device places the set of items into an interior compartment of the first partial order tote. At least one sensor device associated with the robotic picker device scans each item in the set of items placed into the first partial order tote. A robotic cart transports the first set of items in a first partial order tote to an automated storage induction portal.

The system analyzes scan data generated from scanning the order to create removable tote used to track partial orders as they are inducted and after induction. The system can identify the order parts based on the labels. This aids in the quick reinsertion of cold chain compliance items to a climate-controlled environment and also eliminates the associate's (or robot's) sit and wait time in the event that a fellow associate's (or robot's) portion of the order picking takes longer, thus improving overall efficiency of the picker's time.

Alternatively, or in addition to the other examples described herein, examples include any combination of the following:
outputting a graphical representation of a location of each partial order tote in a first set of partial order totes associated with the first multipart order via a first color-coded graphic;
outputting a graphical representation of a location of each partial order tote in a second set of partial order totes associated with the second multipart order via a second color-coded graphic;
a robotic picker device retrieves the first set of items corresponding to the first portion of the multipart order, wherein the robotic picker device places the set of items into an interior compartment of the first partial order tote;
at least one sensor device associated with the robotic picker device scans each item in the set of items placed into the first partial order tote;
a robotic cart transports the first set of items in a first partial order tote to an automated storage induction portal;
an update component, implemented on the at least one processor, updates a list of unpicked items associated with an incomplete portion of the multipart order on condition induction of the first partial order tote is completed successfully based on an inventory of items in the first partial order tote;
a second partial order tote associated with the first multipart order, wherein the second partial order tote is inducted into the automated storage device at a second induction time-period, wherein the second induction time-period is a different time-period than the first induction time-period;
an inventory manager, implemented on the at least one processor, identifies completed portions of the multipart order based on an inventory of items associated with each partial order tote inducted into the automated storage device and the multipart order data;
wherein the inventory manager identifies incomplete portions of the multipart order based on missing items associated with unreceived items in the multipart order;
a first induction point associated with a first induction portal inducts the first partial order tote associated with the first multipart order into the automated storage device at a first induction time, wherein the first partial order tote comprises ambient temperature items;
a second induction point associated with the first induction portal inducts a second partial order tote associated with a second multipart order into the automated storage device at the first induction time, the second partial order tote comprising chilled or frozen items in an insulated tote, wherein both ambient temperature items, chilled item and frozen items are inducted into the automated storage device at a same time via a same induction portal;
a routing component, implemented on the at least one processor, routes the first partial order tote to a holding area within the automated storage device until all partial order totes associated with the multipart order are inducted into the system;
a routing component, implemented on the at least one processor, routes a set of partial order totes associated with the multipart order to a set of consecutive storage slots within the automated storage device;
a mapping component, implemented on the at least one processor, outputs an identification of a location of each tote in the set of partial order totes to at least one user via the user interface device;
receiving, via a first induction point, a first partial order tote associated with a first multipart order into an automated storage device at a first induction time while a remaining portion of the first multipart order is unpicked, the first partial order tote comprising a first removable tote label identifying the first multipart order and the first partial order tote;
receiving, via a second induction point, a second partial order tote associated with a second multipart order into the automated storage device at the first induction time, the second partial order tote comprising a second removable tote label identifying the second multipart order and the second partial order tote;
receiving, via the first induction point, a third partial order tote associated with the first multipart order into the automated storage device at a second induction time, the third partial order tote comprising a third removable tote label identifying the first multipart order and the third partial order tote, wherein the second induction time occurs after the first induction time;
tracking, by an order manager, an induction duration for each partial order tote inducted into the automated storage device;
generating, by an alert component, a notification identifying a set of unreceived items associated with the first multipart order on condition a set of unreceived items associated with the first multipart order remains un-inducted into the automated storage device at an occurrence of a maximum wait threshold time;
outputting, via a user interface device, an incomplete order notification associated with the first multipart order, the incomplete order notification comprising an identification of each item in the set of unreceived items and the induction duration for each item in a set of received items associated with the multipart order inducted into the automated storage device;
scanning each item placed into the first partial order tote via a set of sensor devices;
generating an inventory of the first partial order tote comprising an identification of each item in the first partial order tote;
outputting a partial order status identifying a location of the first partial order tote and the third partial order tote within the automated storage device via a user interface device, wherein the partial order status includes a multipart order identifier associated with the first multipart order;
displaying, via the user interface device, an order status for the first multipart order, the order status comprising an identification of each partial order tote in a set of partial order totes associated with the first multipart order, an induction time of each tote in the set of totes, an inventory of each tote in the set of partial order totes, an induction duration of each tote in the set of partial order totes and a list of unreceived items identifying each unreceived item requested in the first multipart order which remains un-inducted into the automated storage device;
outputting, by a mapping component, an identification of a location of each tote in the set of partial order totes to at least one user via the user interface device;
routing, by a routing component, implemented on the at least one processor, routes a set of partial order totes associated with the multipart order to a set of consecutive storage slots within the automated storage device;
outputting a graphical representation of a location of each partial order tote in a first set of partial order totes associated with the first multipart order via a first color-coded graphic;
outputting a graphical representation of a location of each partial order tote in a second set of partial order totes associated with the second multipart order via a second color-coded graphic;
picking, via a robotic picking device, the set of items for placement within a given partial order tote for fulfillment of a portion of a selected multipart order;
transporting, via a robotic cart device, the given partial order tote to an induction portal associated with the automated storage device for induction;
identifying a first set of items within a first partial order tote based on scan data generated by a set of sensor devices associated with the set of items;
generating a removable tote label identifying the first partial order tote and a first multipart order corresponding to the set of items;
inducting the first partial order tote into an automated storage device at a first induction time via an induction portal;
routing the first partial order tote to a holding area within the automated storage device on condition at least a portion of the first multipart order remains un-inducted into the automated storage system;
outputting a partial order induction notification via a user interface device identifying the set of received items inducted into the automated storage system and a set of unreceived items associated with the multipart order;
displaying, via the user interface device, a graphical representation of each partial order tote in a set of partial order totes associated with the first multipart order relative to a plurality of other partial order totes within the automated storage device;
generating an alert on condition at least one item in the set of unreceived items remains un-inducted into the automated storage device on occurrence of a maximum threshold wait time;
identifying a second set of items within a second partial order tote corresponding to the first multipart order based on scan data generated by the set of sensor devices;
generating a second removable tote label identifying the second partial order tote and the first multipart order;
inducting the second partial order tote into an automated storage device via an induction portal at a second induction time occurring after the first induction time;
routing the second partial order tote to a holding area within the automated storage device on condition at least a portion of the first multipart order remains un-inducted into the automated storage system; and
outputting an identification of a location of each tote in the set of partial order totes to at least one user via the user interface device and an induction duration for each tote in the set of partial order totes.

At least a portion of the functionality of the various elements in FIG. 1, FIG. 2, FIG. 3, FIG. 4, FIG. 5, FIG. 6, FIG. 7, FIG. 8, FIG. 9 and FIG. 10 can be performed by other elements in FIG. 1, FIG. 2, FIG. 3, FIG. 4, FIG. 5, FIG. 6, FIG. 7, FIG. 8, FIG. 9 and FIG. 10, or an entity (e.g., processor 106, web service, server, application program, computing device, etc.) not shown in FIG. 1, FIG. 2, FIG. 3, FIG. 4, FIG. 5, FIG. 6, FIG. 7, FIG. 8, FIG. 9 and FIG. 10.

In some examples, the operations illustrated in FIG. 11 and FIG. 12 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of managing staggered induction of partial order totes into an automated storage device. The method includes identifying a first partial order tote associated with a first multipart order inducted into an automated storage device at a first induction time while a remaining portion of the first multipart order is unpicked, the first partial order tote comprising a first removable tote label identifying the first multipart order and the first partial order tote; identifying a second partial order tote associated with the first multipart order inducted into the automated storage device at a second induction time, the second partial order tote comprising a second removable tote label identifying the first multipart order and the second partial order tote, wherein the second induction time occurs after the first induction time; outputting an incomplete order notification associated with the first multipart order via a user interface; and generating a notification identifying a set of unreceived items associated with the first multipart order on condition a set of unreceived items associated with the first multipart order remains un-inducted into the automated storage device at an occurrence of a maximum wait threshold time.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for managing staggered induction of partial orders at a set of induction points. For example, the elements illustrated in FIG. 1, FIG. 2, FIG. 3, FIG. 4, FIG. 5, FIG. 6, FIG. 7, FIG. 8, FIG. 9 and FIG. 10, such as when encoded to perform the operations illustrated in FIG. 11 and FIG. 12, constitute exemplary means for inducting a first partial order tote associated with a first multipart order into an automated storage device at a first induction time while a remaining portion of the first multipart order is unreceived; exemplary means for inducting a second partial order tote associated with the first multipart order into the automated storage device at a second induction time; exemplary means for outputting an incomplete order notification associated with the first multipart order including an identification of each item in a set of unreceived items and an induction duration for each item in a set of received items associated with the multipart order inducted into the automated storage device; and exemplary means for generating a notification identifying a set of unreceived items associated with the first multipart order on condition a set of unreceived items associated with the first multipart order remains un-inducted into the automated storage device at an occurrence of a maximum wait threshold time.

Other non-limiting examples provide one or more computer storage devices having a first computer-executable instructions stored thereon for providing staggered induction of partial orders into an automated storage device. When executed by a computer, the computer performs operations including analyzing sensor data generated by a set of sensor devices to identify a set of items associated with a first partial order tote associated with a first portion of a multipart order created by a user; generating a first removable tote label identifying the first partial order tote and the multipart order is generated; outputting an order status identifying received items in the multipart order inducted into the automated storage device, an induction time of each partial order tote, and unreceived items from the multipart order un-inducted into the system based on the multipart order data associated with at least one removable tote label on at least one tote inducted into the automated storage device; and generating an alert on condition a second partial order tote associated with a second portion of the multipart order remains unreceived after a threshold maximum wait time.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of.” The phrase “one or more of the following: A, B, and C” means “at least one of A and/or at least one of B and/or at least one of C.”

In an exemplary embodiment, one or more of the exemplary embodiments include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system can be reduced significantly. For example, whenever localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data can include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI can be discarded depending upon the degree to which such KRI has any value based on local processing and evaluation of such KRI. In an exemplary embodiment, KRI may not even be utilized in any form if it is determined that KRI is transient and can be considered as signal noise. Furthermore, in an exemplary embodiment, the kernel rejects generic data to provide a modified kernel (“KRG”) by filtering incoming raw data using a stochastic filter that thereby provides a predictive model of one or more future states of the system and can thereby filter out data that is not consistent with the modeled future states which can, for example, reflect generic background data. In an exemplary embodiment, KRG incrementally sequences all future undefined cached kernels of data to filter out data that can reflect generic background data. In an exemplary embodiment, KRG further incrementally sequences all future undefined cached kernels having encoded asynchronous data to filter out data that can reflect generic background data.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for managing staggered induction of partial orders into automated storage, the system comprising:
at least one processor communicatively coupled to a memory;
a set of scan devices configured to scan each item in a first set of items for placement within a first partial order tote associated with a first portion of a multipart order created by a selected user;
a first removable tote label identifying the first partial order tote and the multipart order is generated;
an induction portal inducts the first partial order tote, including the first removable tote label, into an automated storage device at a first induction time-period on condition the first portion of the multipart order is complete, wherein a second portion of the multipart order is incomplete when the first partial order tote is inducted;
a user interface device outputs an order status identifying received items in the multipart order inducted into the automated storage device, an induction time of each partial order tote, and unreceived items from the multipart order which are un-inducted into the system based on multipart order data associated with at least one removable tote label on at least one tote inducted into the automated storage device; and
an order manager component, implemented on the at least one processor, outputs an alert on condition a second partial order tote associated with the second portion of the multipart order remains unreceived after a threshold maximum wait time.

2. The system of claim 1, further comprising:
a graphical representation of a location of each partial order tote in a first set of partial order totes associated with a first multipart order output via the user interface device, wherein the graphical representation includes a first color-coded graphic; and
the user interface device outputting a graphical representation of the location of each partial order tote in a second set of partial order totes associated with a second multipart order, including a second color-coded graphic.

3. The system of claim 1, further comprising:
a mapping component, implemented on the at least one processor, outputs an identification of a location of each tote in a set of partial order totes to at least one user via the user interface device.

4. The system of claim 1, further comprising:
an update component, implemented on the at least one processor, updates a list of unreceived items associated with an incomplete portion of the multipart order on condition induction of the first partial order tote is completed successfully based on an inventory of items in the first partial order tote.

5. The system of claim 1, further comprising:
the second partial order tote associated with the multipart order, wherein the second partial order tote is inducted into the automated storage device at a second induction time-period, wherein the second induction time-period is a different time-period than the first induction time-period.

6. The system of claim 1, further comprising:
an inventory manager, implemented on the at least one processor, identifies completed portions of the multipart order based on an inventory of items associated with each partial order tote inducted into the automated storage device and the multipart order data, and wherein the inventory manager identifies incomplete portions of the multipart order based on the unreceived items in the multipart order.

7. The system of claim 1, further comprising:
a first induction point associated with a first induction portal inducts the first partial order tote associated with a first multipart order into the automated storage device at a first induction time, wherein the first partial order tote comprises ambient temperature items; and
a second induction point associated with the first induction portal inducts the second partial order tote associated with a second multipart order into the automated storage device at the first induction time, the second partial order tote comprising chilled or frozen items in an insulated tote, wherein the ambient temperature items are inducted into the automated storage device at a same time as the chilled or frozen items via a same induction portal.

8. The system of claim 1, further comprising:
a routing component, implemented on the at least one processor, routes the first partial order tote to a holding area within the automated storage device until all partial order totes associated with the multipart order are inducted into the system.

9. The system of claim 1, further comprising:
a routing component, implemented on the at least one processor, routes a set of partial order totes associated with the multipart order to a set of consecutive storage slots within the automated storage device.

10. A computer-implemented method for managing staggered induction of partial order totes into a storage device, the computer-implemented method comprising:
inducting, via a first induction point, a first partial order tote associated with a first multipart order into an automated storage device at a first induction time while a remaining portion of the first multipart order is unpicked, the first partial order tote comprising a first removable tote label identifying the first multipart order and the first partial order tote;
inducting, via the first induction point, a second partial order tote associated with the first multipart order into the automated storage device at a second induction time, the second partial order tote comprising a second removable tote label identifying the first multipart order and the second partial order tote, wherein the second induction time occurs after the first induction time;
outputting, via a user interface device, an incomplete order notification associated with the first multipart order, the incomplete order notification comprising an identification of each item in a set of unreceived items and an induction duration for each item in a set of received items associated with the first multipart order inducted into the automated storage device; and
generating, by an alert component, a notification identifying the set of unreceived items associated with the first multipart order on condition the set of unreceived items associated with the first multipart order remains un-inducted into the automated storage device at an occurrence of a maximum wait threshold time.

11. The computer-implemented method of claim 10, further comprising:
scanning each item placed into the first partial order tote via a set of sensor devices; and
generating an inventory of the first partial order tote comprising the identification of each item in the first partial order tote.

12. The computer-implemented method of claim 10, further comprising:
outputting a partial order status identifying a location of the first partial order tote and the second partial order tote within the automated storage device via the user interface device, wherein the partial order status includes a multipart order identifier associated with the first multipart order.

13. The computer-implemented method of claim 10, further comprising:
tracking, by an order manager, the induction duration for each partial order tote inducted into the automated storage device; and
displaying, via the user interface device, an order status for the first multipart order, the order status comprising an identification of each partial order tote in a set of partial order totes associated with the first multipart order, an induction time of each tote in the set of totes, an inventory of each tote in the set of partial order totes, the induction duration of each tote in the set of partial order totes and a list of unreceived items identifying each unreceived item in the set of unreceived requested in the first multipart order which remains un-inducted into the automated storage device.

14. The computer-implemented method of claim 10, further comprising:
outputting, by a mapping component, an identification of a location of each tote in a set of partial order totes to at least one user via the user interface device.

15. The computer-implemented method of claim 10, further comprising:
routing, by a routing component, implemented on at least one processor, a set of partial order totes associated with the first multipart order to a set of consecutive storage slots within the automated storage device.

16. The computer-implemented method of claim 10, further comprising:
outputting a first graphical representation of a location of each partial order tote in a first set of partial order totes associated with the first multipart order via a first color-coded graphic; and
outputting a second graphical representation of the location of each partial order tote in a second set of partial order totes associated with a second multipart order via a second color-coded graphic.

17. The computer-implemented method of claim 10, further comprising:
inducting, via a second induction point, a third partial order tote associated with a second multipart order into the automated storage device at the first induction time, the third partial order tote comprising a third removable tote label identifying the second multipart order and the third partial order tote; and
inducting, via a third induction point, a fourth partial order tote associated with the second multipart order into the automated storage device at the second induction time.

18. One or more computer storage media, having computer-executable instructions for managing staggered induction of totes into a storage device that, when executed by a computer cause the computer to perform operations comprising:
identifying a first set of items within a first partial order tote based on scan data generated by a set of sensor devices;
generating a removable tote label identifying the first partial order tote and a first multipart order corresponding to the set of items;
inducting the first partial order tote into an automated storage device at a first induction time via an induction portal;
routing the first partial order tote to a holding area within the automated storage device on condition at least a portion of the first multipart order remains un-inducted into an automated storage system;
outputting a partial order induction notification via a user interface device identifying a set of received items inducted into the automated storage system and a set of unreceived items associated with the first multipart order; and
displaying, via the user interface device, a graphical representation of each partial order tote in a set of partial order totes associated with the first multipart order relative to a plurality of other partial order totes within the automated storage device.

19. The one or more computer storage media of claim 18 further comprising computer-executable instructions that cause the computer to perform operations comprising:
identifying a second set of items within a second partial order tote corresponding to the first multipart order based on scan data generated by the set of sensor devices;
generating a second removable tote label identifying the second partial order tote and the first multipart order;
inducting the second partial order tote into an automated storage device via an induction portal at a second induction time occurring after the first induction time; and
routing the second partial order tote to a holding area within the automated storage device on condition at least a portion of the first multipart order remains un-inducted into the automated storage system.

20. The one or more computer storage media of claim 18 further comprising computer-executable instructions that cause the computer to perform operations comprising:
outputting an identification of a location of each tote in the set of partial order totes to at least one user via the user interface device and an induction duration for each tote in the set of partial order totes; and
generating an alert on condition at least one item in the set of unreceived items remains un-inducted into the automated storage device on occurrence of a threshold maximum wait time after induction of the first partial order tote.
